(19) United States
(12) Patent Application Publication
(10) Pub. No.: US 2005/0061186 A1
(43) Pub. Date: Mar. 24, 2005

(54) Disposable printing roller

(75) Inventors: Erik S. Larson, Norwood, MA (US); William Edward Mansfield JR., Sandwich, MA (US)

Correspondence Address: Thomas E. Hagar, 129 Boston Post Road, Wayland, MA, 01778, US

(73) Assignee: Engineered Plastics Solution Group

(21) Appl. No.: 10/981,425

(22) Filed: Nov. 4, 2004

Related U.S. Application Data
(63) Continuation-in-part of application No. 10/327,478, filed on Dec. 20, 2002.

(51) Int. Cl. B41C 1/00

(52) U.S. Cl. 101/483

(57) ABSTRACT

The invention relates to printing rollers that are used in the dry offset printing industry. Presently there are no effective disposable printing rollers designed for use in printing presses used in the dry offset printing industry. The invention comes in different designs depending on the particular press involved. The invention can be manufactured and sold at a cost similar to the resurfacing costs of the present non-disposable printing rollers but is as structurally sound as a non-disposable printing roller. The invention provides the convenience of being disposable saving time and cost to the printer. The high administrative and logistic costs associated with resurfacing printing rollers are eliminated with the present invention. One need only use the disposable printing roller once and simply dispose of it once the roller is no longer useful.

This application is a continuation-in-part of a U.S. application, application Ser. No. 10,327,478, filed on Dec. 20, 2002.

### BACKGROUND

a) Field of the Invention

This invention relates to the industry of printing rollers used in the dry offset printing industry. More specifically, the invention relates to printing rollers used in the plastic printing industry. The invention is a unique and effective disposable printing roller designed to replace the existing printing rollers in the industry that are presently non-disposable and replace the disposable printer rollers that are currently not effective.

Presently there is a need in the plastic printing industry for an effective low cost and efficient disposable printing roller that performs in a dry offset printing press. Solid core printer rollers provide a strong structural roller but at a high manufacturing cost. On the other hand, a hollow core roller is less expensive to manufacture but is not as structurally sound and thus can fail or break during operation in a printing press. There is a longstanding need in the dry offset printing industry to combine the structural integrity of a solid core roller with the cost effectiveness of a hollow core roller. The present invention fills such a void.

b) Description of the Related Art

The plastic printing industry uses dry offset printing techniques to print on a variety of surfaces such as cups, containers, buckets, lids, etc. Two typical configurations of a dry offset printer are displayed in FIGS. 1 and 2. The printing ink is metered through a series of rollers and drums (12 through 22) from an ink well 24 to a printing drum 10 which is typically referred to as a plate cylinder. The type of printing press in FIG. 1 consists of a combination of seven rollers and drums. The first roller 20, commonly called a ductor roller, removes ink from the ink well 24. The ink is then transferred from the ductor roller 20 to a pair of idler rollers, an upper idler roller 18 and a lower idler roller 16. The ink is transferred to a drum 22 and then onto two form rollers, an upper form roller 12 and a lower form roller 14. The two form rollers then transfer a preset amount of ink on to the plate cylinder 10. Most of the printing presses follow this general configuration with the only difference being the number of individual rollers and/or drums. A different printing press configuration can be seen in FIG. 2. This press is similar in design as the one shown in FIG. 1 but with the addition of two additional drums 22.

Regardless of the design of the printing press the principle of dry offset printing is to meter ink from the ink well 24 to the plate cylinder 10. By adjusting the tolerances, or gaps, between the given rollers and drums in the press an operator can meter the amount of ink, or the thickness of the ink applied, to the plate cylinder 10. The printing rollers in the prior art can be made from a solid material or can be made with a hollow core. FIGS. 3 and 4 show two different types of rollers that are used in the press shown in FIG. 2. FIG. 3 shows a partial cut away view of an upper idler roller 18 made out of a solid block of metal, typically aluminum. FIG. 4 shows cross-sectional view of an upper form roller 12 made from a hollow core of metal that is also typically made out of aluminum.

In FIG. 3 the idler roller 18 consists of a roller portion 30, a flanged portion 32 and a journal 34. The roller portion 30 is cylindrical in shape. Disposed on the outer surface of the roller portion 30 is a rubber material 36 that is vulcanized on to the roller portion 30. The journal 34 is designed to accept a bearing thereby allowing the roller to be connected to the printing press. This roller is typically made out of a solid cylindrical block of aluminum and then machined down to the shape shown in FIG. 3. The machining process requires a great deal of time and manufacturing costs to complete. The fact that the roller is made out of a solid block of material results in a high material cost for the roller. In addition, the solid core roller is heavier than a hollow core roller.

FIG. 4 displays a hollow core upper form roller 12. Typically a hollow roller is made from a hollow cylindrical tube of metal such as aluminum. The hollow core 38 is cut to length and the ends are machined to accept a bearing block 40. The bearing block 40 is made from a metal material, such as aluminum, and is mechanically pressed into the end of the hollow core 38. A typical ball bearing 26 is made from a metal material such as steel and is pressed into the bearing block 40. A rubber layer 36 is disposed on the outer surface of the hollow core 38. Although hollow core rollers do not have the high material expense as solid core rollers, some hollow core rollers do have high machining costs required to machine the core and bearing units. In addition, hollow core rollers can experience a phenomenon of the roller “spinning out” due to the high shear stresses encountered by a roller in a printing press. “Spinning out” occurs when the fit between the hollow core and the end plug fails due to the shear stress of the printing press causing the hollow core to “spin” around the end plug. In the case of the roller in FIG. 4 the hollow core 38 will “spin” around the bearing block 40. When a roller experiences a “spin out” quite often damage can occur to the roller, the rubber on the roller, the roller's bearings, the press, or a combination of the above. When a “spin out” occurs, down time is encountered, as an operator needs to stop the press, change the roller and reset the press setup.

Both of the rollers shown in FIGS. 3 and 4 are designed for resurfacing, or recovering, after the rubber is worn. Typically the rubber is worn over several uses of the printing roller or by operator error. The printing process requires the rollers to spin at high rates of speed and under high contact pressure. Consequently, as the printing press operates, the rubber on the rollers becomes worn and will be required to be replaced, which is an expensive process. The resurfacing process begins by having the operator remove the worn roller from the printing press and setting it aside for future shipment to the manufacturer of the printing roller, or a third party roller recovering house, for resurfacing. Alternatively, the resurfacing house can pick up the rollers at the printer. Either way, the printing roller is resurfaced with a new rubber covering using the same metal core and returned to the printer. The resurfacing of the roller is a significant cost. In addition to the resurfacing house's fees and shipping cost, there are also administration costs and logistics related to the collecting, shipping, receiving and storing of the resurfaced printing rollers. There is significant time and cost associated with the resurfaced rollers as one needs to store the rollers in a spare location and inventory each roller type. Typically in a printing house using resurfaced rollers the printer operator needs to first removed the roller from the press and place it in a safe location. Unfortunately, this is not always done because at the time a worn roller is removed from the press the operator is generally busy or simply forgets and the roller can be misplaced or potentially lost. If the roller is not lost a second individual is usually charged with the duty of collecting the rollers for shipment to the resurfacing house. When the rollers are returned from the resurfacing house this person then has to inventory the roller and needs to maintain the stock of each roller to ensure that the printer has enough rollers of each type to keep the printing presses running. The above referenced work requires time and labor, both of which are an expense for the printer.

Alternatively, there are other printer roller designs that are allegedly cost effective enough to be deemed disposable. One such design is the Brown Patent (U.S. Pat. No. 3,750,250) that utilizes a hollow core with a keyway connection for the press fit of the end caps into the hollow core (see FIG. 3 of Brown Patent). In this particular orientation the keys and keyways are used such that the keys provided take the shear stress created by the printing press in the hope that the design will not experience a “spin out” during operation of the press. However, the keyway press fit device has several drawbacks. First, there are costs involved with making the keyway end cap and keyways in the roller as one or both have to be milled or broached. Second, the high shear stresses of a printing press are localized around the keys and not around the circumference of the connection in the fit. Third, because of the localized stress points at the keys the latter are designed to and quite offer break off or become loose causing the same problems with the rollers “spinning out” and damaging other rollers and/or the rubber on any of the given rollers in the press. Consequently, the keyway press fit designed rollers are not used in the dry offset printing industry due to the several inherent drawbacks to the design.

The present invention overcomes the obstacles of the prior art, as it is an effective and uniquely designed printing roller that does not experience “spin out” while at the same time having a low manufacturing costs so that it is cost effective enough that it can be used as a disposable printing roller. It typically comes in a three-piece construction of a hollow core and two end caps and uses an ingenuous and novel thermal press fit to fit the end caps into the hollow core to create a tight fit that can withstand the shear stresses created by the printer press during its operation, a novel improvement over all prior designs. The above-mentioned high administrative time and costs associated with a non-disposable roller are eliminated with the present invention. In addition, the novel thermal press fit eliminates the common problem of rollers “spinning out” during operation as encountered with the mentioned hollow core designs of the prior art as those designs only have an keyway press fit or a mechanical press fit, both of which are ineffective in a printing press.

The operator merely disposes the printing roller once the rubber covering has become worn. The administrative costs and time attributed to resurfacing rollers and inventorying the same are eliminated. The invention comes in many designs depending on the application required; presently, there are two main applications. The first design can be seen in FIGS. 6, 7 and 7A. FIGS. 7 and 7A show the completed invention. FIG. 6 shows the essential elements of the invention. The hollow core 50 is made from an inexpensive metal such as steel. Alternatively, the hollow core 50 could also be made out of aluminum. The hollow core 50 is cut to a desired length. The end caps 52 are made from a casting and then machine clean. The casting of the end caps 52 saves money in the manufacturing costs as one does have the increased labor cost involved with extensive machining an end cap as with the prior art (see FIG. 3). Alternatively, the end caps can be machined from a solid block of material.

Each of the end caps 52 is pressed into each end of the hollow core 50 using a thermal press fit. The thermal press fit is a novel improvement over the standard mechanical press fit or a keyway pressed fit and creates a robust fit that will not fail when used in a dry offset printing press. Typically, a mechanical press fit is accomplished when one item of a given outside diameter is pressed into another item with an inner diameter that is less than the outer diameter of item pressed. The difference between the two said diameters is called the interference. Generally, the maximum interference that can be achieved before deformation of the either of the two parts is about two thousandths (0.002) of an inch. This interference does not create a strong enough fit to withstand the shear stresses created in a dry offset printing press. Typically, a roller with a standard mechanical press fit will experience a “spinning out” of the roller around the end plug or journal. That is, the fit will fail and the inside of the roller will spin around the outer diameter of the end plug or journal causing numerous problems with the printing press operation and damage to the rollers in the press. The same problem of the rollers “spinning out” is encountered with the keyway press fit as the keys will fail.

All of the problems encountered by a mechanical press fit device or a keyway press fit device are resolved with the present invention's novel thermal press fit. Essentially the end caps are machined so that the outer diameter of the end cap is about two thousandths (0.002) of an inch larger that the inner diameter of the hollow core (the maximum interference allowed for a mechanical press fit). In addition, the end caps are cooled using dry ice, refrigeration, or other cooling method and the hollow core is heated using a propane torch, or other heating method, to a point that an additional six thousandths (0.006) of an inch difference is achieved between the two diameters due to combination of the thermal expansion of the hollow core and the thermal shrinking of the end caps. The pieces are then press fit together making a total of about eight thousandths (0.008) of an inch interference between the outer diameter of the end cap and the inner diameter of the hollow core with zero deformation of the material. This eight thousandths (0.008) of an inch interference creates an extremely strong interface that is strong enough to withstand the shear stresses encountered with a dry offset printing press and will not result in the “spinning out” as encountered with a standard mechanical press fit or keyway press fit. Also this design is an improvement over the keyway design as it is both stronger by design and cost effective, as one does not have to mill or broach the keys and keyways.

The rubber 54 is disposed on the outside surface of the hollow core 50 and is vulcanized using heat and pressure onto the hollow core 50. The printing roller can also be made with the inclusion of an internal bearing housing as shown in FIGS. 5, 5A and 5B. The present invention can be manufactured and sold for a cost similar to the cost of resurfacing an existing non-disposable solid core roller and therefore can be used in a disposable manner. Given the results achieved with the thermal press fit preventing the common problem of “spinning out” of hollow core rollers the present invention achieves the benefits of a solid core rollers but at the costs and convenience of a hollow core roller.

### SUMMARY OF THE INVENTION

The present invention is directed to disposable printing rollers for the dry offset printing industry. More specifically, the present invention is designed for the plastic printing industry for printing cups, containers, buckets, lids, etc. The novel design incorporates the same strength and durability as present non-disposable solid core printing rollers without the high cost and maintenance while at the same time being a novel improvement over prior designs. The invention provides the ease of single use rollers at a similar cost of most resurfacing roller. The invention comes in different styles depending on the application and the printing press used.

In one form the invention contains end caps that are designed to hold a bearing so that the printing roller can be interfaced with the printing press. Another design has an internal bearing housing so that it too can be interfaced with the printing press. Both designs incorporate the cost savings of a hollow core roller but with the benefits of a solid core roller. The invention can be made into any roller design depending on the design requirements of the printing press.

Accordingly, one object of this invention is to provide an inexpensive disposable printing roller for the plastic dry offset printing industry for printing plastic cups, containers, buckets, lids, etc.

Another object of this invention is to provide a disposable printing roller to streamline the printing process by eliminating the need to have the roller resurfaced each time the rubber covering is worn.

A third object of this invention is to streamline the logistical management of the printing industry by not requiring and needing to inventory the rollers that need to be resurfaced, inventorying the resurfaced rollers and the requirement of a staging area for resurfaced rollers.

A fourth object of this invention is to have thermally press fit end caps that will not spin out under the shear stresses encountered with a typically dry offset printing press.

A fifth object of this invention is to have a printing roller that incorporates and combines the structural integrity of a solid core roller with the convenience and cost effectiveness of a hollow core roller.

Other objects and advantages of this invention will become apparent from the following detailed description taken in conjunction with the accompanying drawings.

### BRIEF DESCRIPTION OF THE DRAWINGS

These and other features, aspects and advantages of the present invention will become better understood with reference to the following description, appended claims, and accompanying drawings where,

FIG. 1.0 is a cross-sectional view of an existing printing press,

FIG. 2.0 is a cross-sectional view of an existing printing press,

FIG. 3.0 is a partial cut away plan view of a prior art printing roller (solid core design),

FIG. 4.0 is a cross-sectional view of a prior art printing roller (hollow core design),

FIG. 5.0 is a cross-sectional view of the invention (internal bearings version),

FIG. 5.0A is a detail partial cross-sectional of the notch area (internal bearings version),

FIG. 5.0B is an end plan view of the invention (internal bearings version),

FIG. 6.0 is an exploded plan view of the invention (external bearings version),

FIG. 7.0 is a cross-sectional view of the invention (external bearings version),

FIG. 7.0A is an end plan view of the invention (external bearings version),

FIG. 8.0 is a plan view of an end cap (external bearings version).

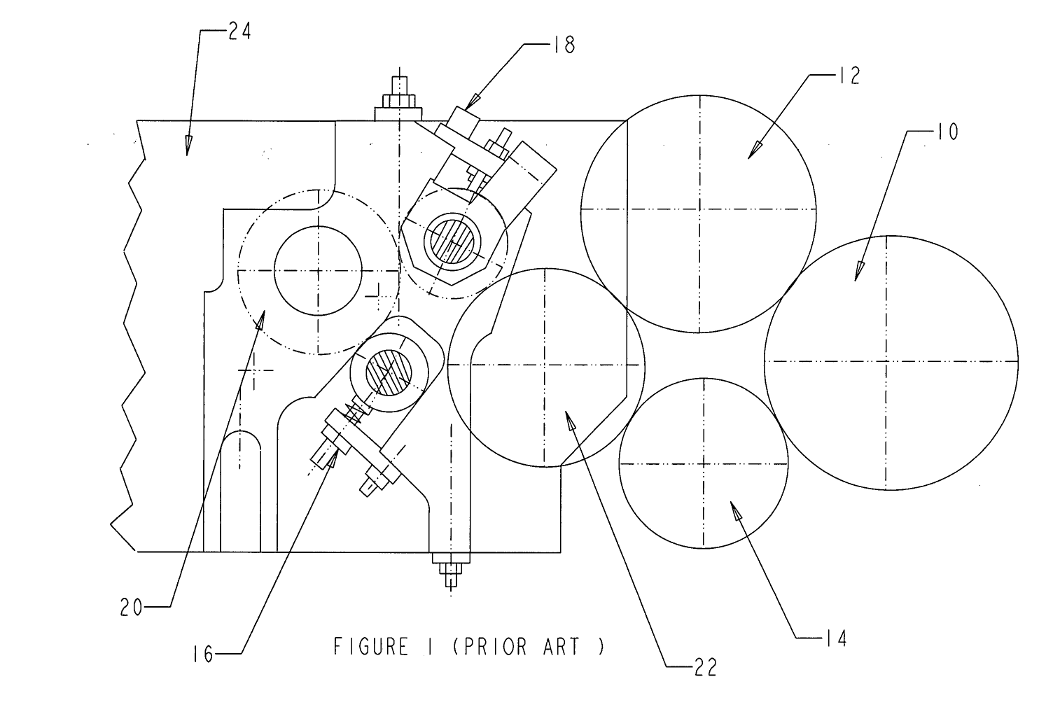

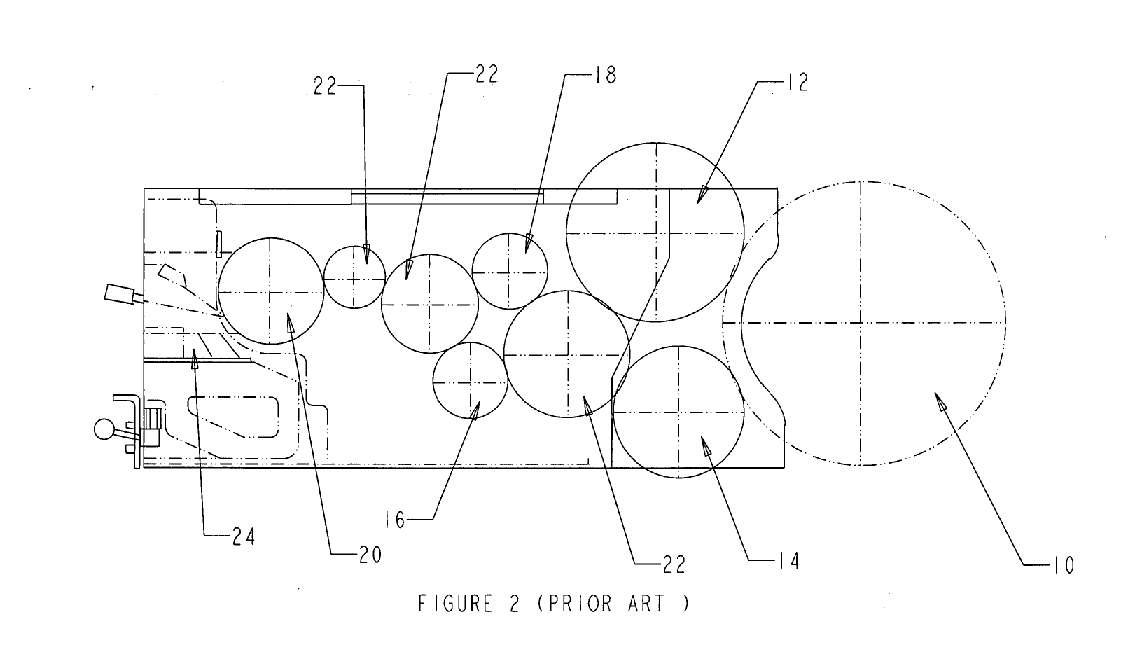

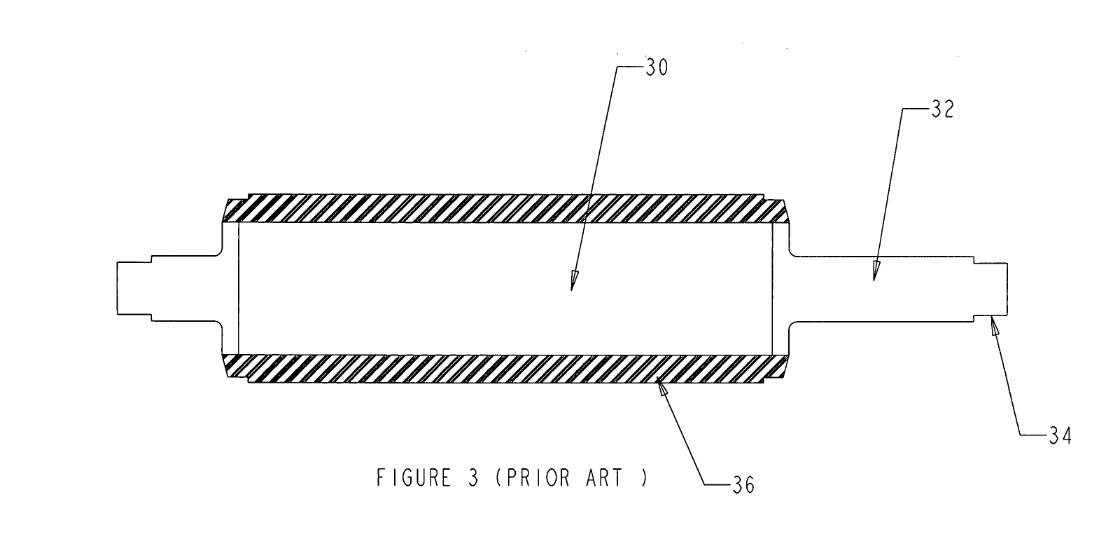

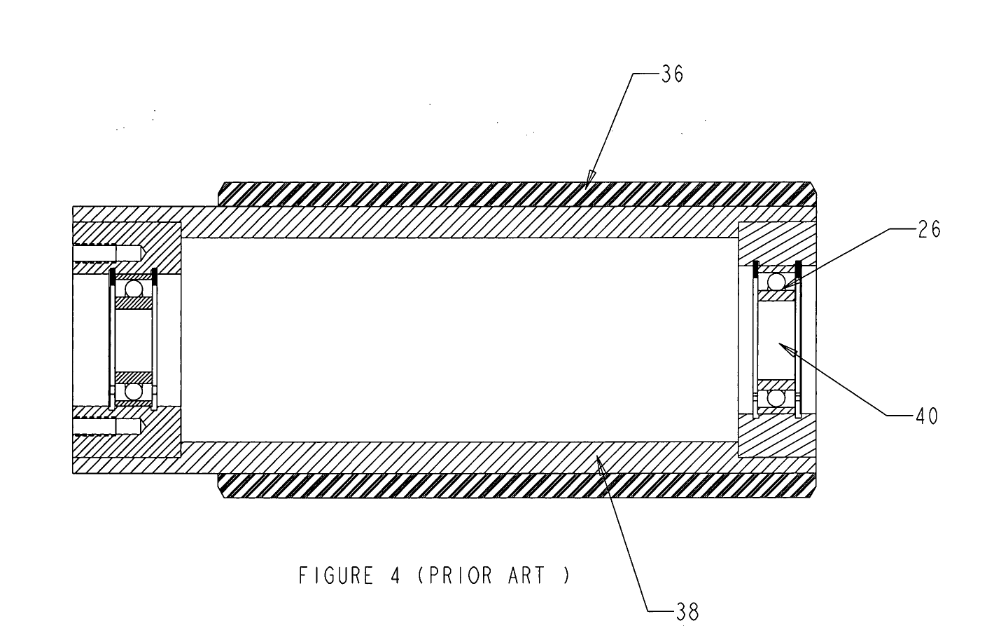

### DETAILED DESCRIPTION OF THE PREFERRED EMBODIMENT

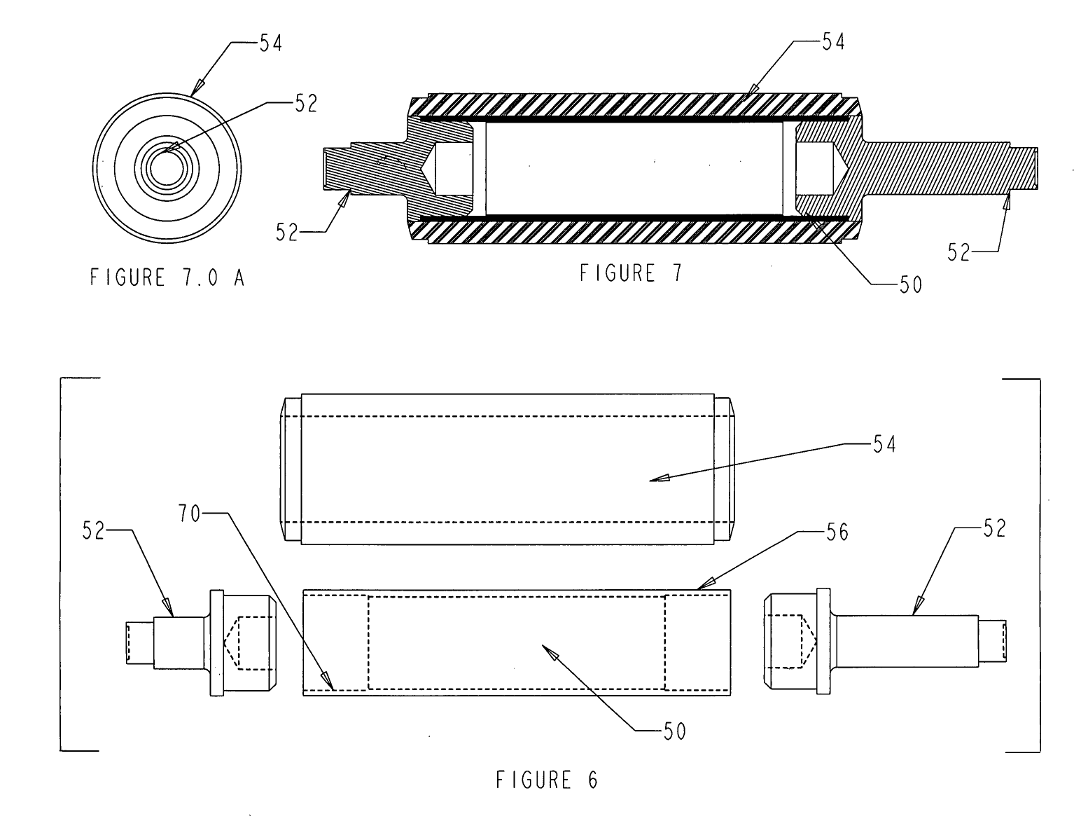

Referring to the Figures and more specifically FIGS. 6, 7 and 7A, the invention consists of a hollow core 50 made from a strong and inexpensive metal with the preferred embodiment being steel. The hollow core 50 may also be made out of aluminum. The hollow core 50 is cylindrical in shape and has an inner diameter and an outer diameter. There is an opening at each end of the hollow core 50. The hollow core 50 has an inside surface 70 and an outside surface 56. The hollow core 50 is cut to a desired length depending on the printing roller requirements.

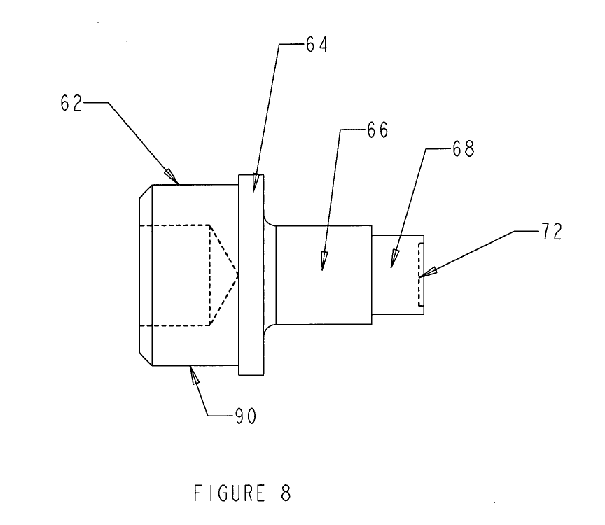

The invention also consists of two end caps 52 that are designed to work in conjunction with the hollow core 50. There is a right end cap and a left end cap. Referring to FIG. 8 the end cap consists of a protrusion 62, a flange 64, an extension 66 and a journal 68 containing a slot 72. The protrusion 62 has an outer surface 90 and is specifically designed to engage with the inner surface 70 of the hollow core 50. The flange 64 is designed to work as a stop for the end cap 52 into the hollow core 50. To accomplish this the diameter of the flange 64 is larger than the inner diameter of the hollow core 50 so that the flange 64 will rest against the hollow core 50 once the end cap 52 is disposed within the hollow core 50.

The extension 66 holds the journal 68 that is designed to accept a bearing so that the invention can be used in a standard offset printer. The bearing is pressed onto the journal 68 using standing pressing techniques. The slot 72 in the journal 68 is designed to hold a “C” ring to hold the bearing on the roller. Alternative, the slot 72 is not machined into the journal 68 and the bearing is secured to the journal 68 by swaging over the end of the journal 68 onto the side of the bearing. The only difference between the two end caps 52 is the length of the extension 66.

Each end cap 52 is cast into it shape using standard casting techniques. Alternatively, the end cap 52 can be machined from a solid block of material. The preferred embodiment of the end cap 52 is made from a strong but inexpensive metal such as steel. Alternatively, the end cap 52 could be made from aluminum or a strong plastic material such as thick walled nylon. The end cap 52 is thermally pressed into hollow core 50 such that the outer surface 90 of the protrusion 62 is engaged with the inner surface 70 of the hollow core 50. To ensure a tight and press fit, the outside diameter of the outer surface 90 of the protrusion 62 is a few thousands of an inch larger than the inner diameter of the inner surface 70 of the hollow core 50, with the preferred embodiment being two thousandths (0.002) of an inch difference between the two diameters. To aid in securing a tight press fit, the hollow core 50 is heated via a propane torch, acetylene torch, or other heating method, and the end cap 52 is cooled via dry ice, refrigeration, or other cooling method, so that an additional six thousandths (0.006) of an inch difference is achieved between the two said diameters resulting in a total of eight thousandths (0.008) of an inch interference between the outer surface 90 of the end cap 52 and inner surface 70 of the hollow core 50, the pieces are then pressed together. A very strong and tight interface is created so when the roller is subjected to the pressures and shear stresses of a offset printing press the hollow core will not “spin out” around the end cap as encountered with a standard mechanical press fit or a keyway press fit.

To assembly the invention one simply adds the appropriate bearing on the end of the journal 68 and a C-ring is disposed in the slot 72. Alternatively, the end of the journal 68 can be swaged over to secure the bearing to the journal 68. Once both bearings are placed and secured onto the end caps the invention is ready to be placed in the appropriate location in the printing press. The rubber 54 is the disposed on the outside surface 56 of the hollow core 50. The rubber 54 is attached to the outside surface 56 of the hollow core 50 using heat-pressurized rubber vulcanization techniques.

Once the rubber becomes worn such that the roller is not efficient, the roller is simply removed and discarded. There is no longer a need to keep a stockpile of new and resurfaced rollers on hand. One can simply purchases the roller once and has a simple inventory of single use rollers on the shelf which can be used as necessary. Once the inventory of a given roller is near depletion the manager simply orders more rollers of that given type. No longer is there a need, or the costs associated with, the retaining of rollers and the administration logistics and costs associated with having them resurfacing and inventoried.

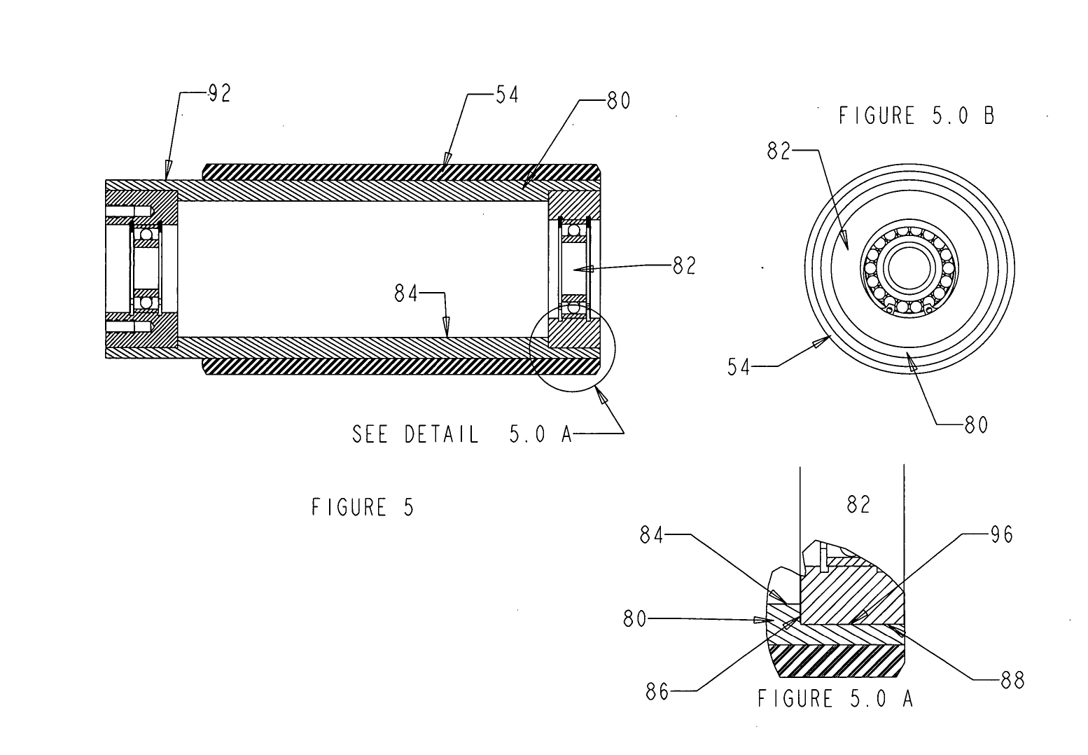

FIGS. 5, 5A and 5B display a version of the invention with internal bearings as presently required by some printing presses. The concept, design and method of manufacture is the same as the above mentioned version of the invention but the bearings are contained in a bearing housing 82 which itself is disposed within the hollow core 80 of the roller. As with the prior version there is a hollow core 80 that is made from an inexpensive material such as steel and cut to a desired length. Alternatively, aluminum could be used for the hollow core 80. The hollow core has an inner surface 84 and an outer surface 92.

The hollow core 80 is made from a cylindrical tube and therefore has to two open ends. Each open end is machined such that a notch is created to accept the bearing housing 82. The notch has a diameter that is greater than the inner diameter of the hollow core 80. The notch is machined from the hollow core 80 until a stop 86 is created. The stop 86 provides a means to secure and stop the bearing housing 82 inside the hollow core 80. The notch has a surface 88 that is designed to interface with the outer surface 96 when the bearing housing 82 is disposed in the notch. The bearing housing 82 may be cast using standard casting techniques. The bearing housing may be made from any strong metal such as steel or aluminum.

To ensure a tight and robust press fit, the outer diameter of the bearing housing 82 is a few thousands of an inch larger than the diameter of the notch, with the preferred embodiment being two thousandths (0.002) of an inch difference between the two diameters. To aid in securing a tight press fit, the hollow core 80 is heated via a propane torch, acetylene torch or other heating method, and the bearing housing 82 is cooled via dry ice, refrigeration, or other cooling method, so that an additional six thousandths (0.006) of an inch difference is achieved between the two said diameters resulting in a total of about eight thousandths (0.008) of an inch interference between the outer surface 96 of the bearing housing 82 and surface 88 of the notch. The bearing housing 82 is then simply pressed using standard pressing techniques into the notch of the hollow core 80 until it rest against the stop 86. A very strong and tight interface is created so when the roller is subjected to the pressures and shear stresses of a printing press the hollow core will not “spin out” around the end cap as encountered with a standard mechanical press fit or a keyway press fit. After the bearing housing 82 is thermally press fit into the hollow core 80, rubber 54 is pressure and heat vulcanized on to the outer surface 92 of the hollow core 80. The roller is complete and ready for use in a printer.

1) A Disposable Printing Roller comprising a hollow core with an outer surface and inner surface, an outer diameter and an inner diameter, and two opening ends each containing a notch;
where the diameter of the notch is greater than the inner diameter but less than the outer diameter of the hollow core;
a bearing housing having an outer diameter that is larger than the inner diameter of the notch and where bearing housing is disposed within the notch;
where the notch is designed to accept the bearing housing;
where the bearing housing is thermally press fit into the notch of the hollow core;
whereby the bearing housing is cooled and the hollow core is heated and the items are then press fit together;
where rubber is heat and pressure vulcanized to the outer surface of the hollow core.

2) A Disposable Printing Roller as in claim 1 where the hollow core is made from steel.

3) A Disposable Printing Roller as in claim 1 where the hollow core is made from aluminum.

4) The process of making a Disposable Printing Roller comprising the steps of cutting a hollow core to a desired length, machining a notch in each end of the hollow core to accept a bearing housing, where the bearing housing is cast into shape with an outer diameter that is larger than the diameter of the notch and is fitted into the notch using a thermal press fit whereby the hollow core is heated and the bearing housings are cooled followed by the bearing housings being press fit into the notch, where rubber is heat and pressure vulcanized to the exterior of the hollow core.
